(19) United States
(12) Patent Application Publication
(10) Pub. No.: US 2019/0333103 A1
(43) Pub. Date: Oct. 31, 2019

(54) METHOD AND SYSTEM FOR DISTRIBUTION OF ADVERTISEMENT FRAUD DATA TO THIRD PARTIES

(71) Applicant: Affle (India) Limited, Mumbai City (IN)

(72) Inventors: Anuj Khanna SOHUM, Singapore (SG); Charles Yong Jien FOONG, Singapore (SG); Anurag SINGH, Gurgaon (IN)

(73) Assignee: Affle (India) Limited, Mumbai City (IN)

(21) Appl. No.: 16/399,775

(22) Filed: Apr. 30, 2019

(30) Foreign Application Priority Data
Apr. 30, 2018 (IN) 201821016234

(51) Int. Cl. G06Q 30/02

(52) U.S. Cl. CPC G06Q 30/0248; G06Q 30/0277

(57) ABSTRACT

The present disclosure provides a method and system for distribution of mobile advertisement fraud data to one or more third parties. The data sharing platform receives a connection request from one or more third parties to access fraud data. In addition, the data sharing platform correlate the third party data from the one or more third parties and the fraud data. Further, the data sharing platform optimize selected rules for the identification of fraud done by the publisher. Furthermore, the data sharing platform analyze publisher data, application data and the fraud data collected after correlation. Moreover, the data sharing platform generates report in a pre-defined interval of time. Also, the data sharing platform shares the report with the one or more third parties based on a pre-defined criteria.

### TECHNICAL FIELD

The present disclosure relates to the field of fraud detection systems and, in particular, relates to a method and system for distribution of advertisement fraud data to the third parties.

### INTRODUCTION

With the advancements in technology over the last few years, users have predominantly shifted towards smartphones for accessing multimedia content. Nowadays, users access content through a number of mobile applications available for download through various online application stores. Businesses (Advertisers) have started focusing on generating revenue by targeting consumers through these mobile applications. In addition, businesses have started investing heavily on doing business through these mobile applications. Moreover, businesses (publisher and/or advertising networks) have started developing advertisement capable applications for serving advertisements through these mobile applications. These advertisements are published in real time or fixed placements through these mobile applications and watched by the users. The advertisers are benefited in terms of internet traffic generated on clicking, taking action like installing or on watching these advertisements. However, certain online publisher and advertising networks working with these publishers take undue advantage of this in order to generate high revenues. These online publishers and advertising networks employ fraudulent techniques in order to generate clicks, or increasing actions like increasing number of application installs for the advertisers through fraudulent means. In addition, these online publishers incentivize the users for clicking the links, downloading applications and the like. This results in a loss of advertisers marketing budget spent as many times these publishers claim a normal user-initiated action (Organic action, e.g. Organic Install) as one initiated by them or at times the clicks or application installs are not driven by humans at all and instead by bots. There is a consistent need to stop publishers from performing such types of click fraud and transaction fraud.

### SUMMARY

In one aspect, the present disclosure provides a computer system. The computer system includes one or more processors and a memory. The memory is coupled to the one or more processors. The memory stores instructions. The instructions are executed by the one or more processors. The execution of instructions causes the one or more processors to perform a method to detect advertisement fraud based on time between events. The method includes a first step to receive a connection request from the one or more third parties to access the fraud data. In addition, the method includes second step to correlates the third party data received from the one or more third parties and the fraud data. The correlation is done after authorizing the one or more third parties for accessing the fraud data. Further, the method includes third step to optimize selected rules for the identification of fraud done by the publisher. Furthermore, the method includes fourth step to analyze publisher data, application data and the fraud data collected after correlation. Moreover, the method includes fifth step to generate a report in a pre-defined interval of time. Moreover, the method includes sixth step to share the report with the one or more third parties based on a pre-defined criteria. The connection request includes set of data and third party data associated with at least one publisher. The correlation is done in real time. The optimization is done based on the set of data received from the one or more third parties. The analysis is done after the optimization of the selected rules for identification of fraud. The analysis is done to identify the publisher in blacklist or whitelist. The report include the publisher who are using genuine means or fraud means for publishing of one or more advertisements on one or more media devices. The report is shared with the one or more third parties by sending a notification to the one or more third parties in real time.

In an embodiment of the present disclosure, the fraud data may include blacklist and whitelist. The blacklist may include the publisher showing fraudulent activity. The whitelist may include the publisher using genuine means for showing the one or more advertisements on the one or more media devices. The fraud data represents the publisher in the blacklist or whitelist by way of IP address and device Id's.

In another embodiment of the present disclosure, the set of data may include thresholds for identifying the publisher as fraud, rules for adding the publisher in the blacklist and rules for adding the one or more users in the blacklist. In addition, the set of data may include rules for adding the publisher in the whitelist and rules for adding the one or more users in the whitelist. Further, the set of data may include rules for removing the publisher from the whitelist and rules for removing the one or more users from the whitelist.

In yet another embodiment of the present disclosure the publisher data may includes number of click, past revenue generated by the publisher, number of transaction, location of click, number of install, interaction data and time-stamp.

In yet another embodiment of the present disclosure, the application data includes application size, time to download, time to run, redirection time, click to install and click to run. In addition, the application idea includes user click time, device load time, time to run, time to install, network download time, application usage time, application idle time and application opening time.

In yet another embodiment of the present disclosure, the selected rules may include rules for adding the publisher in the blacklist and rules for adding the one or more users in the blacklist. In addition, the selected rules may include rules for adding the publisher in the whitelist, rules for adding the one or more users in the whitelist and rules for removing the publisher from the whitelist. Further, the selected rules may include rules for removing the publisher and the one or more users in the blacklist. The rules are conditions specified by the one or more third parties in order to list the publisher in the whitelist or the blacklist.

In yet another embodiment of the present disclosure, the one or more third parties may include cyber security provider, one or more advertisers, one or more advertisements networks and stakeholders.

In yet another embodiment of the present disclosure, the pre-defined criteria may include category of publishers, category of advertisers and number of frauds by each fraudulent entity. In addition, the pre-defined criteria may include threshold number of frauds detected for each fraudulent entity, trends in money earned by publishers through ad clicks, relevancy of fraud data for corresponding third party, type of fraud data and location data related to fraud.

In yet another embodiment of the present disclosure, the data sharing platform may authorize the publisher based on the analysis. The authorization is done to allow the publisher to publish the one or more advertisements on the one or more media devices and add the publisher in the whitelist.

In yet another embodiment of the present disclosure, the data sharing platform may block the publisher based on the analysis. The blocking is done to stop the publisher from publishing one or more advertisements on one or more media devices and add the publisher in the blacklist.

### BRIEF DESCRIPTION OF DRAWINGS

Having thus described the invention in general terms, references will now be made to the accompanying figures, wherein:

FIG. 1 illustrates an interactive computing environment between users and one or more components for distribution of mobile advertisement fraud data to third parties in real time, in accordance with various embodiments of the present disclosure;

FIGS. 2A and 2B illustrate a flow chart of a method for distribution of advertisement fraud data to third parties, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

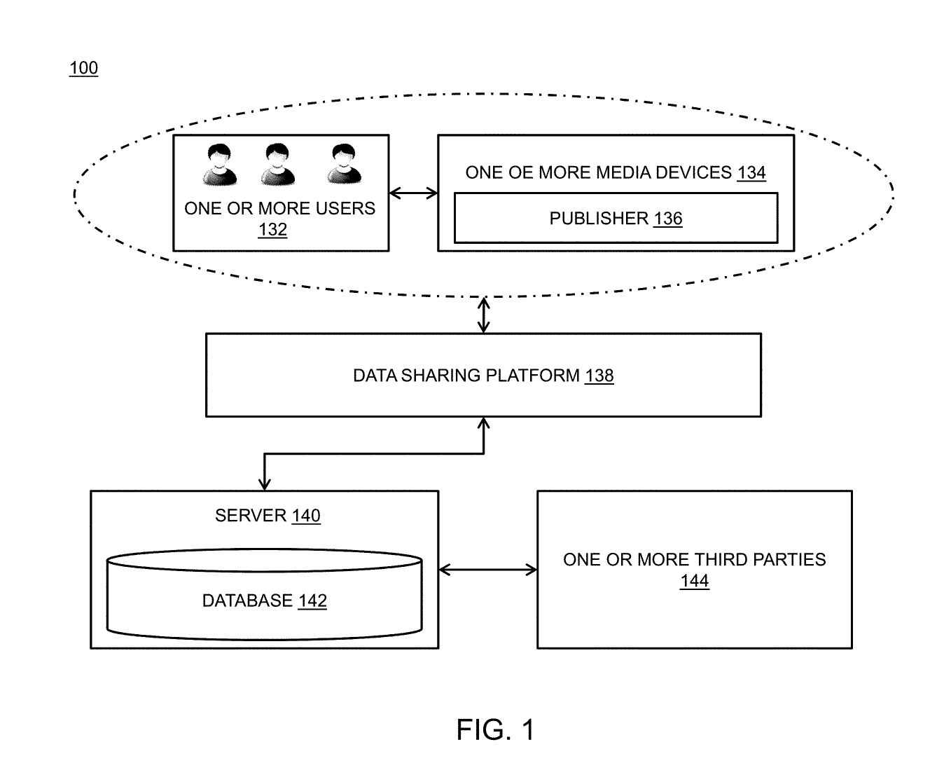

FIG. 1 illustrates an interactive computing environment 100 for distribution of or more advertisements frauds to third parties in real time. The interactive computing environment 100 shows a relationship between various entities involved in the distribution of advertisement frauds to third parties. The advertisement fraud is a type of fraud which is done to generate more revenue from the one or more advertisements being displayed by generating fake install or clicks. The fake install is done with the help of software, bots. The fake install or fake traffic is done through techniques such as click fraud, transaction fraud and the like. The click fraud corresponds to regular or constant clicking by one or more users 132 on the one or more advertisements in order to generate more revenue for a publisher. The click fraud is when the publisher gets paid based on pay-per-click or pay-per-view whenever the one or more advertisements is clicked. The click fraud refers to the generation of fraudulent clicks through online bots which are not identifiable and are treated as genuine install. The transaction fraud refers to initiating install via fake clicks and bots (as described above in the application). The transaction fraud takes place when the publisher applies fraudulent techniques to drive fake installs of applications in order to generate more revenue.

The interactive computing environment 100 includes the one or more users 132, one or more media devices 134, a publisher 136, a data sharing platform 138, a server 140, a database 142 and one or more third parties 144. Each of the components of the interactive computing environment 100 interacts with each other to share advertisement fraud data in real-time.

The interactive computing environment includes the one or more users 132 who is any person present at any location and access the multimedia content. The one or more users 132 is any legal person or natural person who access online multimedia content and need an IP based network for accessing the multimedia content. In addition, the one or more users 132 are individuals or persons who accesses online multimedia content on the respective one or more media devices 134. In another embodiment of the present disclosure, the one or more users 132 are a computer or bots who is programmed to view the one or more advertisements and performs click and transaction. In an embodiment of the present disclosure, the one or more users 132 includes but may not be limited to a natural person, legal entity, the individual, machine and robots for viewing the one or more advertisements. The one or more users 132 are associated with the one or more media devices 134.

The interactive computing environment further includes the one or more media devices 134 which help to communicate information. The one or more media devices 134 includes but may not be limited to a Smartphone, a laptop, a desktop computer, a tablet and a personal digital assistant. In an embodiment of the present disclosure, the one or more media devices 134 include a smart television, a workstation, an electronic wearable device and the like. In an embodiment, the one or more media devices 134 include portable communication devices and fixed communication devices. In an embodiment of the present disclosure, the one or more media devices 134 are currently in the switched-on state. The one or more users 132 are accessing the one or more media devices 134 in real-time. The one or more media devices 134 are any type of devices having an active internet. The one or more media devices 134 are an internet-enabled device for allowing the one or more users 132 to access the publisher 136. In an embodiment of the present disclosure, the one or more users 132 are owner of the one or more media devices 134. In another embodiment of the present disclosure, the one or more users 132 are not the owner of the one or more media devices 134. In addition, the one or more media devices 134 are used for viewing an application installed on the one or more media devices 134.

The interactive computing environment 100 further includes the publisher 136 used for viewing content on the one or more media devices 134. The publisher 136 includes but may not be limited to mobile application, web application, and website. The publisher 136 is the mobile application which displays content to the one or more users 132 on the one or more media devices 134. The content may include one or more publisher content, one or more video content and the like. The application or the publisher 136 accessed by the one or more users 132 shows content related to the interest of the one or more users 132. In an example, the one or more users 132 are interested in watching online videos, reading blogs, play online games, accessing social networking sites and the like. The publisher 136 is the application developed by the application developer for viewing or accessing specific content. The publisher 136 or applications are advertisement supporting applications which are stored on the one or more media devices 134. The publisher 136 or mobile applications are of any type which includes gaming application, a utility application, a service based application and the like. The publisher 136 provides space; frame, area or a part of their application pages for advertising purposes is referred to as advertisement slots. The publisher 136 consists of various advertisement slots which depend on the choice of the publisher 136. The publisher 136 advertises products, services or businesses to the one or more users 132 for generating revenue. The publisher 136 displays one or more advertisements on the one or more devices 134 when the one more users 132 are accessing the publisher 136.

The one or more advertisements are a graphical or pictorial representation of the information to promote a product, an event, service and the like. In general, the one or more advertisements are a medium for promoting a product, service, or an event. The one or more advertisements include text advertisement, video advertisement, graphic advertisement and the like. The one or more advertisements are displayed in third party applications developed by application developers. The one or more advertisements are presented for attracting the one or more users 132 based on the interest in order to generate revenue. The one or more advertisements are shown to the one or more users 132 based on the interest of the one or more users 132 and shown for a specific period of time. The one or more users 132 clicks on the one or more advertisements and the one or more users 132 is re-directed to a website or application or application store associated with the clicked one or more advertisements. The one or more advertisements are providing to the publisher 136 by one or more advertisers who want to advertise their product, service through the publisher 136. The publisher 136 gets paid if the one or more users 132 visit the application or website through the one or more advertisements of the one or more advertisers. The number of users who visits the one or more advertisements through the publisher 136 generates more revenue for the publisher 136.

The one or more advertisers are those who want to advertise their product or service and the like to the one or more users 132. The one or more advertisers approach the publisher 136 and provide the one or more advertisements for display for the one or more users 132 on the publisher 136. The one or more advertisers pay the publisher 136 based on the number of users being redirected or taking the product or services provided by the one or more advertisers.

The one or more advertisements are placed on the advertisement slots in the publisher application on the one or more media devices 134 associated with the one or more users 132. The one or more advertisers purchase the advertisement slots from the publisher 136. The one or more advertisements may be served based on a real-time bidding technique or a direct contract between the one or more advertisers and the publisher 136. The one or more advertisers provide the one or more advertisements to advertising networks and information associated with advertising campaigns. The advertisement networks enable display of the one or more advertisements in real-time on the publisher 136 on behalf of the one or more advertisers. The advertising networks are entities that connect the one or more advertisers to websites and mobile applications that are willing to serve advertisements.

The interactive computing environment 100 includes the data sharing platform 138. The data sharing platform 138 is used for sharing fraud data with the one or more third parties 144 for finding fraud being done by the one or more users 132 or the publisher 136. The data sharing platform 138 is a platform for integrating with the one or more third parties 144 for detecting fraud done by the one or more users 132 or the publisher 136 in real-time. The data sharing platform 138 performs sharing of fraud data to the one or more third parties 144 in real time and detection of fraud in the one or more advertisements in real time. The data sharing platform 138 performs the fraud detection based on integration with the one or more third parties 144 or the one or more advertisers. The data sharing platform 138 detect click fraud and transaction fraud done by the publisher 136 or the one or more users 132. In an embodiment of the present disclosure, the data sharing system 138 take actions accordingly based on the fraud detected by the data sharing system 138. The data sharing platform 138 is associated with the server 140.

The server 140 performs the task of accepting a request and respond to the request for other functions. The server 140 may be a cloud server which is used for cloud computing to enhance the real-time processing of the system and using virtual space for task performance. The cloud server is built, hosted and delivered through a cloud computing platform. The cloud computing is the process of using remote network server which hosts on the internet to store, manage, and process data. The use of cloud server helps to access the data sharing platform 138 to be accessed from anywhere using the internet. The server 140 performs the task of accepting request and responding to the request of other functions. The server 140 handles each operation and task performed by the data sharing system 138. The server 140 stores one or more instructions for performing the various operations of the data sharing platform 138. In an embodiment of the present disclosure, the data sharing platform 138 is located on the server 140. In another embodiment of the present disclosure, the data sharing platform 138 is located on the one or more media devices 134. The server 140 includes database 142 which is used for storing data in real-time. Further. The server 140 is associated with the one or more third parties 144.

The database 142 is an area where all the information is stored for access during the functioning of the data sharing system 138. The database 142 includes data which is pre-stored in the database 142 and data collected in real-time. In an embodiment of the present disclosure, the database 142 is a cloud database or any other database based on the requirement of the data sharing platform 138. The data is stored in the database 142 in various tables. The tables are a matrix which stored different type of data. In an example, one table may store data related to the one or more users 132 and in another table the one or more media devices 134 related data is stored.

The one or more third parties 144 are those parties who want to identify fraud in their system or method to prevent fraud in real-time. The one or more third parties 144 includes but may not be limited to cyber security provider, one or more advertisers, advertisement networks and stakeholders. The one or more third parties 144 include a bank, payment gateway, security services, and the like. The one or more third parties 144 connect with the data sharing platform 138 to integrate their database with the data sharing platform 138 to identify fraud. The one or more third parties 144 provide access to their database to identify fraud and detect abnormality with the one or more users 132 or the publisher 136. The one or more third parties 144 communicate or access the data sharing platform 138 through the server 140. The one or more third parties 144 sends a connection request to the data sharing platform 138 for accessing the fraud data stored in the data sharing platform 138.

The fraud data include blacklist, whitelist, publisher data, past data and the like. The blacklist includes a list of the publisher 136 showing fraudulent activity which is identified in the past or real-time as performing fraud behavior. The whitelist includes the list of the publisher 136 using genuine means for showing the one or more advertisements on the one or more media devices 134. The fraud data represents the publisher 136 in the blacklist or the whitelist by way of IP address and device Id's.

The data sharing platform 138 receives the connection request from the one or more third parties 144 to access the fraud data. The connection request is received from the one or more third parties through the server 140 for accessing the fraud data. The connection request includes a set of data and third party data. The third party data is associated with at least one publisher 136. The third party data includes the publisher data, the advertisement data collected by the one or more third parties 144 when the one or more users 132 view the one or more advertisements. The publisher data includes but may not be limited to number of click, past revenue generated by the publisher 136 and number of transaction. In an embodiment of the present disclosure, the publisher data includes time stamp, location of click, interaction data, number of install and the like.

The set of data include rules which are provided by the one or more third parties 144 for performing fraud detection after integrating with the one or more third parties 144. The set of data includes but may not be limited to threshold for identifying the publisher 136 as fraud, rules for adding the publisher in the blacklist and rules for adding the one or more users in the blacklist. In an embodiment, the set of data includes rules for adding the publisher in the whitelist and rules for adding the one or more users in the whitelist. In another embodiment, the set of data includes rules for removing the publisher from the whitelist and rules for removing the one or more users from the whitelist.

In addition, the data sharing platform 138 authorize the one or more third parties 144 for accessing the fraud data of the data sharing platform 138 based on the connection request. The authorization of the one or more third parties 138 for accessing the fraud data is done to allow the one or more third parties 144 to access and associate the fraud data. The association of the fraud data of the one or more third parties 144 with the data sharing platform 138 will help to identify the publisher 136 who are performing fraudulent activity. In an embodiment, the authorization of the one or more third parties 144 is done based on username and password provided to the one or more third parties 144. The username and password are provided to the one or more third parties 144 for accessing the data sharing platform 138. In an embodiment of the present disclosure, the authorization of the one or more third parties 144 may be performed by using digital signature which is provided to the one or more third parties 144.

Further, the data sharing platform 138 correlates the third party data received from the one or more third parties and the fraud data. The correlation is done after authorization of the one or more third parties 144. The correlation between the data of the one or more third parties 144 and the fraud data stored in the database 142 is done to identify the publisher 136. The correlation help to enhance the fraud data based on the data collected from the one or more third parties 144 and the fraud data of the data sharing platform 138. The correlation is done in real time.

Furthermore, the data sharing platform 138 optimizes selected rules for identification of fraud being done by the publisher 138. The selected rules for identification of fraud are set of rules defines by the one or more third parties 144 to identify fraud based on the rules received in the set of data. The selected rules are conditions specified by the advertiser or the one or more third parties 144 in order to list a publisher 136 or the one or more users 132 as fraud or genuine. The selected rules are specified by the one or more third parties with the connection request for identifying fraud. The optimization of the selected rules is done based on the set of data received from the one or more third parties 144. The set of data is received from the one or more third parties 144 at the time of the connection request. The set of data are used for optimizing the rules for the at least one of the one or more third parties 144. The selected rules include at least one of rules for adding the publisher in the blacklist, rules for adding the one or more users in the blacklist and rules for adding the publisher in the whitelist. In addition, the selected rules include rules for adding the one or more users in the whitelist, rules for removing the publisher from the whitelist, rules for removing the publisher and the one or more users in the blacklist.

In an example, third parties X send connection request to the data sharing platform 138 for accessing the fraud data. The connection request includes the set of data and the third party data associated with the at least one publisher 136. The data sharing platform 138 authorizes the third parties X and further correlation is done between the third party data of the publisher 136 and the fraud data of the data sharing platform 138. The after correlation of the fraud data, the data sharing system 138 optimize the selected rules based on the set of data received with the connection request. The optimization is done to identify fraud based on the selected rules set by the third party X.

Moreover, the data sharing platform 138 analyzes publisher data, application data and the fraud data collected after correlation. The analysis is done to identify the publisher 136 in the blacklist or the whitelist. The publisher data includes number of click, past revenue generated by the publisher 136, number of transaction and the like. In an embodiment of the present disclosure, the publisher data includes but may not be limited to time stamp, location of click, interaction data and number of install.

The application data includes application size, time to download, time to run, redirection time, click to install, click to run, user click time and the like. In an embodiment of the present disclosure, the application data includes but may not be limited to device load time, time to run, time to install, network download time and application usage time. In another embodiment of the present disclosure, the application data includes application idle time, application opening time, number of user click, network speed, country bandwidth and the like.

The analysis of the publisher data, the fraud data after correlation and the application data is done by the fraud detection platform 138 based on the rules to identify fraud. The fraud detection platform 138 identifies fraud based on the threshold provided in the set of data by the one or more third parties. The threshold is used to mark the publisher 136 or the one or more users 132 as using fraud means. The fraud means is done for generating revenue or the one or more users 132 being bots or a software used for performing click fraud and transaction fraud. The analysis is done to check if the one or more users 132 or the publisher 136 is already present in the whitelist or the blacklist.

Also, the data sharing platform 138 generates a report in a pre-defined interval of time for the one or more third parties 144. The pre-defined interval of time is defined by the one or more third parties 144. The report includes the publisher 136 or the one or more users 132 who are using genuine or fraud means for publishing of the one or more advertisements on the one or more media devices 134. The report generated is sent to the one or more third parties 144 who have integrated with the data sharing platform 138 to inform the status of the publisher 136 or the one or more users 132.

Also, the data sharing platform 138 shares the report with the one or more third parties 144 based on a pre-defined criteria. The report is shared with the one or more third parties 144 by sending a notification to the one or more third parties 144 in real time. The report is shared with the one or more third parties 144 by sending a notification to the one or more third parties 144 in real time.

Also, the data sharing platform 138 blocks the publisher 136 or the one or more users 132 based on the analysis. The blocking of the publisher 136 is done to block the publisher 136 from publishing the one or more advertisements on the one or more media devices 134. The blocking of the one or more users 132 is done to prevent the transaction or download of the publisher 136 (mobile application). The blocking of the publisher 136 is done based on the threshold. If the analysis identifies that the threshold defined in the selected rules is crossed than the publisher 136 is blocked to publish the one or more advertisements on the one or more media devices 134. Further, the data sharing platform 138 adds the publisher 136 or the one or more users 132 in the blacklist.

In an embodiment of the present disclosure, the data sharing platform 138 blocks the publisher 136 or the one or more users 132 by comparing the score of the publisher 136 or the one or more users 132 with the threshold. The identification of the score for the publisher 136 or the one or more users 132 is calculated based on the analysis. The blocking stops the publisher 136 from publishing the one or more advertisements on the one or more media devices 134 and adds the publisher 136 or the one or more users 132 in the blacklist.

Also, the data sharing platform 138 authorize the publisher 136 or the one or more users 132 based on the analysis. The authorization of the publisher 136 is done to allow the publisher 136 for publishing the one or more advertisements on the one or more media devices 134. The authorization is done of the one or more users 132 for performing the transaction or download of the publisher 136 (mobile application). The authorization is done based on the threshold. If the analysis identifies that the threshold defined in the selected rules has not been crossed than the publisher 136 is authorized to publish the one or more advertisements on the one or more media devices 134.

In an embodiment of the present disclosure, the analysis is done to identify a score for the publisher 136 or the one or more users 132. Further, the data sharing platform 138 authorize the publisher 136 or the one or more users 132 by comparing the score of the publisher 136 or the one or more users 132 with the threshold. The authorization allows the publisher 136 to publish the one or more advertisements on the one or more media devices 134. Further, if the data sharing platform 138 identifies that the publisher 136 or the one or more users 132 is not performing any fraud based on the analysis. The data sharing platform 138 removes the one or more users 132 or the publisher 136 from the blacklist. In addition, the data sharing platform 138 adds the publisher 136 or the one or more users 132 in the whitelist of the data sharing platform 138.

Also, the data sharing platform 138 notify the one or more third parties 144 or the one or more advertisers about the publisher 136 using fraud means. The notification is sent by e-mail or message to the one or more third parties or the one or more advertisers in real time. In an embodiment of the present disclosure, the notification is sent to the one or more third parties 144 or the one or more advertisers through any other means suitable for sending a communication.

Also, the data sharing platform 138 integrate with automatic payment network of the one or more third parties 144. The integration with the automatic payment network of the one or more third parties 144 allows the data sharing platform 138 to block the payment of the publisher 136. The blocking of payment of the publisher 136 is done when the analysis identifies that the publisher 136 or the one or more users 132 is present in the blacklist of the fraud data of the data sharing platform 138.

In an embodiment of the present disclosure, the data sharing platform 138 integrate with the fraud data from the third party databases. The integration is done in order to generate fraud data comprising of the publisher 136 and the one or more users 132 who are performing fraud and adding them to the whitelist or blacklist. The integration is done with the fraud data of the third party databases by correlating it with the fraud data of the third party databases.

In another embodiment of the present disclosure, the data sharing platform 138 stores the fraud data, the publisher data, the application data and the selected rules. The data sharing platform 138 stored the data in the database 142 in real-time.

In yet another embodiment of the present disclosure, the data sharing platform 138 updates the fraud data, the publisher data, the application data and the selected rules. The data sharing platform 138 updates the data in the database 142 in real-time.

In an embodiment of the present disclosure, the data sharing platform 138 may distribute fraud data to bona-fide parties who will not use the data to circumvent the fraud platform (common practice of many fraud players is to use anti-fraud systems themselves and change their setup accordingly). In an embodiment of the present disclosure, the data sharing platform 138 checks if dissemination of fraud data to a new third party results in change of behavior/setup immediately and hence conclude that the new third party is not a bona-fide user of the fraud data.

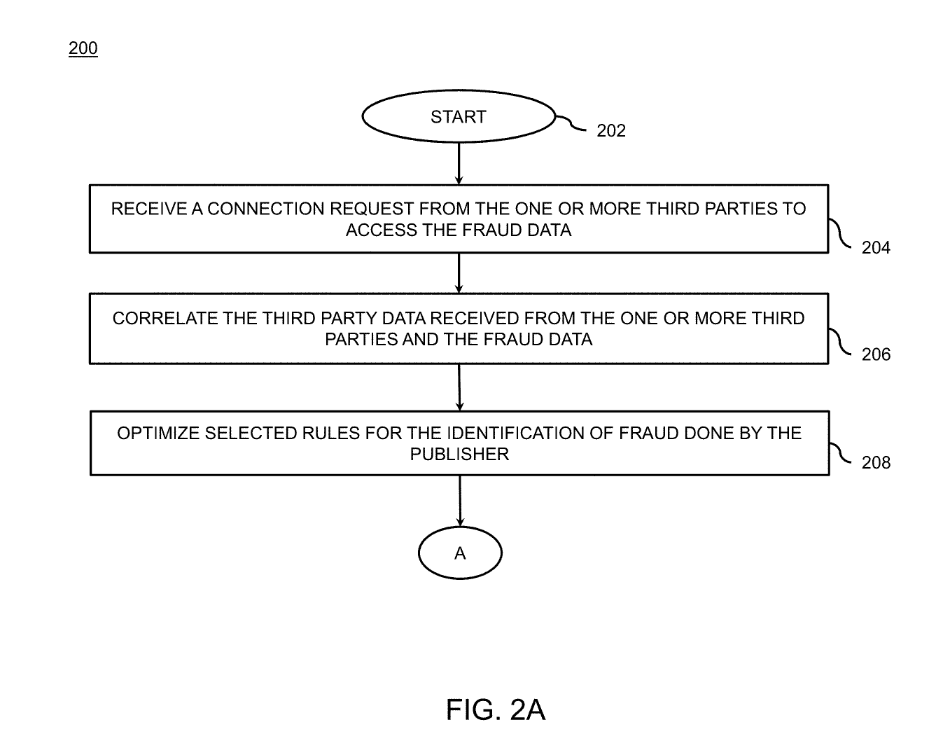

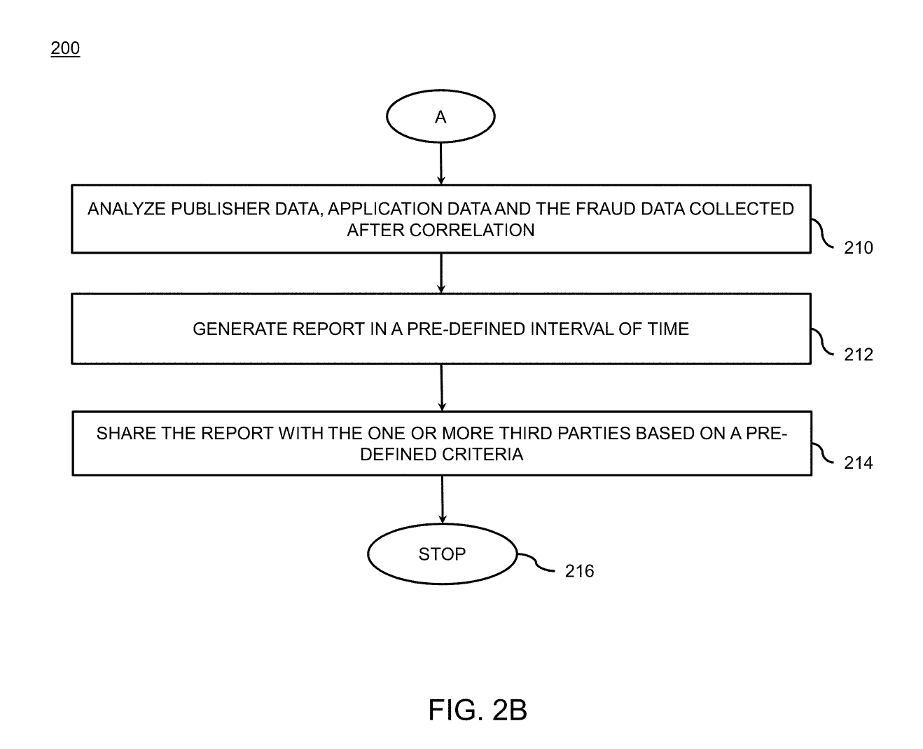

FIGS. 2A and 2B illustrate a flow chart 200 for distribution of advertisement fraud data to one or more third parties in real time, in accordance with various embodiments of the present disclosure. It may be noted that to explain the process steps of flowchart 200, references will be made to the system elements of FIG. 1. It may also be noted that the flowchart 200 may have fewer or more number of steps.

The flowchart 200 initiates at step 202. Following step 202, at step 204, the data sharing platform 138 receives the connection request from the one or more third parties 144 to access the fraud data. At step 206, the data sharing platform 138 correlates the third party data received from the one or more third parties 144 and the fraud data. At step 208, the data sharing platform 138 optimizes the selected rules for the identification of fraud done by the publisher 136. At step 210, the data sharing platform 138 analyzes the publisher data, the application data and the fraud data collected after the correlation. At step 212, the data sharing platform 138 generates the report in the pre-defined interval of time. At step 214, the data sharing platform 138 shares the report with the one or more third parties 144 based on the pre-defined criteria. The flow chart 200 terminates at step 216.

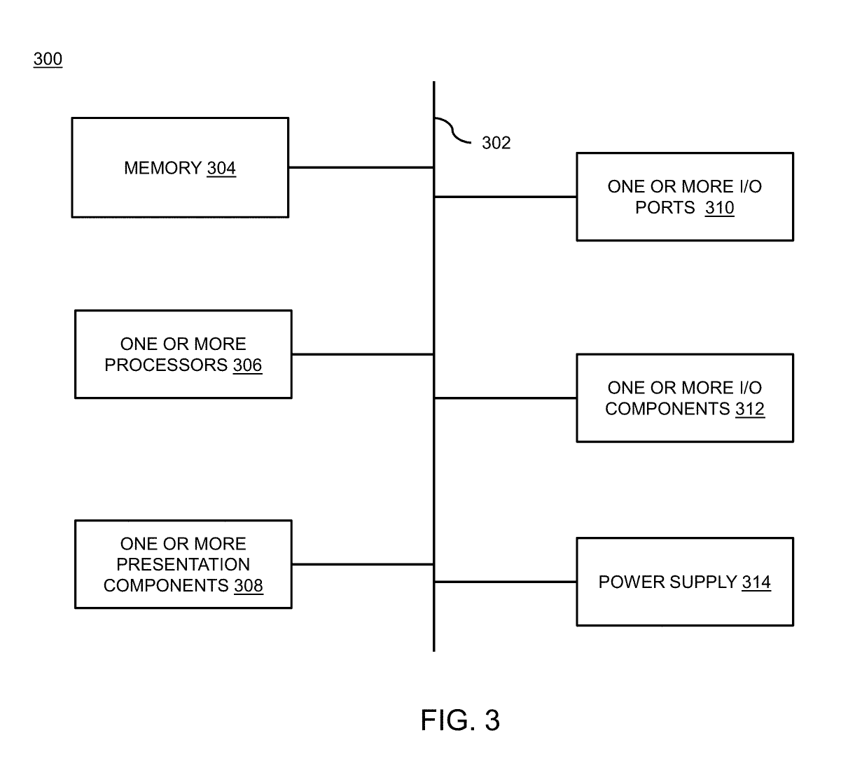

FIG. 3 illustrates a block diagram of a device 300, in accordance with various embodiments of the present disclosure. The device 300 is a non-transitory computer readable storage medium. The device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to the user or other device. Exemplary presentation components include a display device, speaker, printing component, vibrating component, etc. The one or more I/O ports 310 allow the device 300 to be logically coupled to other devices including the one or more I/O components 312, some of which may be built in. Illustrative components include a microphone, joystick, gamepad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer system comprising:
one or more processors; and
a memory coupled to the one or more processors, the memory for storing instructions which, when executed by the one or more processors, cause the one or more processors to perform a method for distribution of advertisement fraud data to one or more third parties in real time, the method comprising:
receiving, at a data sharing platform, a connection request from the one or more third parties to access the fraud data, wherein the connection request comprises set of data and third party data associated with at least one publisher;
correlating, at the data sharing platform, the third party data received from the one or more third parties and the fraud data, wherein the correlation is done after authorizing the one or more third parties for accessing the fraud data, wherein the correlation is done in real time;
optimizing, at the data sharing platform, selected rules for the identification of fraud done by the publisher, wherein the optimizations is done based on the set of data received from the one or more third parties;
analyzing, at the data sharing platform, publisher data, application data and the fraud data collected after correlation, wherein analysis is done after the optimization of the selected rules for identification of fraud, wherein the analysis is done to identify the publisher in blacklist or whitelist;
generating, at the data sharing platform, report in a pre-defined interval of time, wherein the report comprises the publisher who are using genuine means or fraud means for publishing of one or more advertisements on one or more media devices; and
sharing, at the data sharing platform, the report with the one or more third parties based on a pre-defined criteria, wherein the report is shared with the one or more third parties by sending a notification to the one or more third parties in real time.

2. The computer system as recited in claim 1, wherein the fraud data comprises the blacklist and the whitelist, wherein the blacklist comprises the publisher showing fraudulent activity, wherein the whitelist comprises the publisher using the genuine means for showing the one or more advertisements on the one or more media devices, wherein the fraud data represents the publisher in the blacklist or the whitelist by way of IP address and device Id's.

3. The computer system as recited in claim 1, wherein the set of data comprises thresholds for identifying the publisher as fraud, rules for adding the publisher in the blacklist, rules for adding the one or more users in the blacklist, rules for adding the publisher in the whitelist, rules for adding the one or more users in the whitelist, rules for removing the publisher from the whitelist and rules for removing the one or more users from the whitelist.

4. The computer system as recited in claim 1, wherein the publisher data comprises number of click, past revenue generated by the publisher, number of transaction, time stamp, location of click, interaction data and number of install.

5. The computer system as recited in claim 1, wherein the application data comprises application size, time to download, time to run, redirection time, click to install, click to run, user click time, device load time, time to run, time to install, network download time, application usage time, application idle time and application opening time.

6. The computer system as recited in claim 1, wherein the selected rules comprises rules for adding the publisher in the blacklist, rules for adding the one or more users in the blacklist, rules for adding the publisher in the whitelist, rules for adding the one or more users in the whitelist, rules for removing the publisher from the whitelist, rules for removing the publisher from the blacklist and the one or more users in the blacklist, wherein the selected rules are conditions specified by the one or more third parties in order to list the publisher in the whitelist or the blacklist.

7. The computer system as recited in claim 1, wherein the one or more third parties comprises cyber security provider, one or more advertisers, one or more advertisements networks, bank, payment gateway provider, security services and stakeholders.

8. The computer system as recited in claim 1, wherein the pre-defined criteria comprises category of publishers, category of advertisers, number of frauds by each fraudulent entity, threshold number of frauds detected for each fraudulent entity, trends in money earned by publishers through ad clicks, relevancy of fraud data for corresponding third party, type of fraud data and location data related to fraud.

9. The computer system as recited in claim 1, further comprising
authorizing, at the data sharing platform, the publisher based on the analysis, wherein the authorization is done to allow the publisher to publish the one or more advertisements on the one or more media devices and add the publisher in the whitelist.

10. The computer system as recited in claim 1, further comprising
blocking, at the data sharing platform, the publisher based on the analysis, wherein the blocking is done to stop the publisher from publishing one or more advertisements on one or more media devices and add the publisher in the blacklist.

11. A computer-implemented method for distribution of advertisement fraud data to one or more third parties in real time, the computer-implemented method comprising:
receiving, at a data sharing platform with a processor, a connection request from the one or more third parties to access the fraud data, wherein the connection request comprises set of data and third party data associated with at least one publisher;
correlating, at the data sharing platform with the processor, the third party data received from the one or more third parties and the fraud data, wherein the correlation is done after authorizing the one or more third parties for accessing the fraud data, wherein the correlation is done in real time
optimizing, at the data sharing platform with the processor, selected rules for the identification of fraud done by the publisher, wherein the optimizations is done based on the set of data received from the one or more third parties;
analyzing, at the data sharing platform with the processor, publisher data, application data and the fraud data collected after correlation, wherein analysis is done after the optimization of the selected rules for identification of fraud, wherein the analysis is done to identify the publisher in blacklist or whitelist; and
generating, at the data sharing platform with the processor, report in a pre-defined interval of time, wherein the report comprises the publisher who are using genuine means or fraud means for publishing of one or more advertisements on one or more media devices; and
sharing, at the data sharing platform with the processor, the report with the one or more third parties based on a pre-defined criteria, wherein the report is shared with the one or more third parties by sending a notification to the one or more third parties in real time.

12. The computer-implemented method as recited in claim 11, wherein the fraud data comprises the blacklist and the whitelist, wherein the blacklist comprises the publisher showing fraudulent activity, wherein the whitelist comprises the publisher using the genuine means for showing the one or more advertisements on the one or more media devices, wherein the fraud data represents the publisher in the blacklist or the whitelist by way of IP address and device Id's.

13. The computer-implemented method as recited in claim 11, wherein the set of data comprises thresholds for identifying the publisher as fraud, rules for adding the publisher in the blacklist, rules for adding the one or more users in the blacklist, rules for adding the publisher in the whitelist, rules for adding the one or more users in the whitelist, rules for removing the publisher from the whitelist and rules for removing the one or more users from the whitelist.

14. The computer-implemented method as recited in claim 11, wherein the publisher data comprises number of click, past revenue generated by the publisher, number of transaction, time stamp, location of click, interaction data and number of install.

15. The computer-implemented method as recited in claim 11, wherein the application data comprises application size, time to download, time to run, redirection time, click to install, click to run, user click time, device load time, time to run, time to install, network download time, application usage time, application idle time and application opening time.

16. The computer-implemented method as recited in claim 11, wherein the selected rules comprises rules for adding the publisher in the blacklist, rules for adding the one or more users in the blacklist, rules for adding the publisher in the whitelist, rules for adding the one or more users in the whitelist, rules for removing the publisher from the whitelist, rules for removing the publisher from the blacklist and the one or more users in the blacklist, wherein the selected rules are conditions specified by the one or more third parties in order to list the publisher in the whitelist or the blacklist.

17. The computer-implemented method as recited in claim 11, wherein the one or more third parties comprises cyber security provider, one or more advertisers, one or more advertisements networks, bank, payment gateway provider, security services and stakeholders.

18. The computer-implemented method as recited in claim 11, wherein the pre-defined criteria comprises category of publishers, category of advertisers, number of frauds by each fraudulent entity, threshold number of frauds detected for each fraudulent entity, trends in money earned by publishers through ad clicks, relevancy of fraud data for corresponding third party, type of fraud data and location data related to fraud.

19. The computer-implemented method as recited in claim 11, further comprising
blocking, at the data sharing platform with the processor, the publisher based on the analysis, wherein the blocking is done to stop the publisher from publishing one or more advertisements on one or more media devices and add the publisher in the blacklist.

20. A non-transitory computer-readable storage medium encoding computer executable instructions that, when executed by at least one processor, performs a method for distribution of advertisement fraud data to one or more third parties in real time, the method comprising:
receiving, at a computing device, a connection request from the one or more third parties to access the fraud data, wherein the connection request comprises set of data and third party data associated with at least one publisher;
correlating, at the computing device, the third party data received from the one or more third parties and the fraud data, wherein the correlation is done after authorizing the one or more third parties for accessing the fraud data, wherein the correlation is done in real time;
optimizing, at the computing device, selected rules for the identification of fraud done by the publisher, wherein the optimizations is done based on the set of data received from the one or more third parties;
analyzing, at the computing device, publisher data, application data and the fraud data collected after correlation, wherein analysis is done after the optimization of the selected rules for identification of fraud, wherein the analysis is done to identify the publisher in blacklist or whitelist;
generating, at the computing device, report in a pre-defined interval of time, wherein the report comprises the publisher who are using genuine means or fraud means for publishing of one or more advertisements on one or more media devices; and
sharing, at the computing device, the report with the one or more third parties based on a pre-defined criteria, wherein the report is shared with the one or more third parties by sending a notification to the one or more third parties in real time.
